(19) United States
(12) Patent Application Publication
(10) Pub. No.: US 2023/0130728 A1
(43) Pub. Date: Apr. 27, 2023

(54) HAMSTER HOUSE

(71) Applicant: SHENZHEN ZHI NAN REN TECHNOLOGY CO., LTD., SHENZHEN CITY, GUANGDONG PROVINCE (CN)

(72) Inventor: ZHIYANG HU, SHENZHEN CITY, GUANGDONG PROVINCE (CN)

(21) Appl. No.: 17/042,117

(22) PCT Filed: Sep. 11, 2020
(86) PCT No.: PCT/CN2020/114902

§ 371 Date: Sep. 26, 2020

(30) Foreign Application Priority Data
Sep. 11, 2019 (CN) 201921536663.X
Jul. 22, 2020 (CN) 202021469346.3

(51) Int. Cl. A01K 1/03; A01K 1/00

(52) U.S. Cl. CPC A01K 1/03; A01K 1/0058

(57) ABSTRACT

A hamster house, which relates to the technical field of breeding devices, comprises: a box body and a movable door. An active cavity is provided inside the box body, an opening communicating with the active cavity is provided on the box body, and the box body is detachably assembled by several flat plates. The movable door is hinged and used to cover the opening. The box body includes: a bottom plate, side plates, a first panel and a second panel. Two side plates are provided and riveted on two ends of the bottom plate, and the two side plates are oriented to the same direction. The first panel is arranged between the two side plates, and the first panel is oriented to the same direction as the side plates.

### FIELD OF THE DISCLOSURE

The present disclosure relates to the technical field of breeding devices, in particular to a hamster house.

### BACKGROUND OF THE DISCLOSURE

As a kind of pets, hamsters are widely loved by people because of their cuteness and ease of keeping. In order to facilitate the breeding of hamsters, it is usually necessary to prepare a hamster house for hamsters for rest and entertainment.

However, the existing hamster houses are often fixed together by glue, and once the assembly is completed, they cannot be disassembled, which is not convenient for cleaning, storage and transportation.

### SUMMARY OF THE DISCLOSURE

The purpose of the present disclosure is to provide a hamster house in view of the defects and deficiencies of the prior art, which has a stable structure and is convenient for large-scale production. It is easy to assemble the box body, while ensuring the stability of the box body; in addition, the box body can be disassembled into several flat plates when not in use, so that several flat plates can be stacked and placed, thereby saving the advantage of placing space.

In order to achieve the above objective, the technical solution adopted by the present disclosure is to provide a hamster house, comprising: a box body and a movable door, wherein an active cavity is provided inside the box body, an opening communicating with the active cavity is provided on the box body, and the box body is detachably assembled by means of several flat plates, wherein the movable door is hinged to the box body and configured to cover the opening.

The box body comprises: a bottom plate, side plates, a first panel and a second panel, wherein two side plates are provided and riveted with two ends of the bottom plate, and the two side plates are oriented to the same direction, wherein the first panel is arranged between the two side plates, the first panel is oriented to the same direction as the side plates, two ends of the first panel is riveted with one of the side plates respectively, and the first panel is arranged on one side of the bottom plate and one side of the first panel adjacent to the bottom plate is riveted with the bottom plate, wherein the second panel is arranged between the two side plates, the second panel is oriented to the same direction as the side plates, two ends of the second panel are riveted with one of the side plates respectively, and the second panel is arranged on the other side of the bottom plate corresponding to the first panel and one side of the second panel adjacent to the bottom plate is riveted with the bottom plate; and wherein the movable door is arranged on sides of the side plates away from ground, and two ends of the movable door adjacent to one side of the second panel are respectively hinged to one of the side plates.

The middle portions of each of the first panel and side plates are provided with a visible window made of a transparent material.

The box body further comprises: a support plate, wherein two ends of the support plate are riveted with one of the side plates, and one side of the support plate adjacent to the first panel is riveted with the first panel.

A gripping opening is provided on the movable door and a passage opening corresponding to the gripping opening is provided on the support plate.

A limit ring removably assembled on a location where the bottom plate, the first panel, the second panel, the side plates, the movable door and the support plate are riveted.

A plurality of ventilation holes are formed in the movable door.

The box body comprises: a bottom plate, side plates, a top plate, a first panel, a second panel and a movable door, wherein two side plates are provided and fixed oppositely on two ends of the bottom plate, wherein the first panel is arranged between the two side plates, two ends of the first panel are riveted with the two side plates respectively, and the first panel is arranged on one side of the bottom plate and one side of the first panel adjacent to the bottom plate is riveted with the bottom plate, wherein the second panel is arranged between the two side plates, two ends of the second panel are riveted with the two side plates respectively, the second panel is arranged opposite to the first panel, one side of the second panel adjacent to the bottom plate is riveted with one side of the bottom plate away from the first panel, and a height of the first panel is lower than a height of the second panel, wherein the top plate is arranged between the two side plates and located on one side away from ground, two ends of the top plate are riveted with the two side plates respectively, and one side of the top plate is riveted with the second panel, and wherein two ends of one side of the movable door are respectively hinged to sides of the two side plates away from ground, one side of the movable door is located on one side of the top plate away from the second panel, and the other side is located on one side of the first panel away from ground; or the movable door is located between the two side plates, and one side of the movable door is hinged to one side of the top plate away from the second panel.

The two side plates are both in a right-angled pentagonal shape, and parts of the side plates adjacent to the top plate are a right-angle trapezoid shape and parts adjacent to the bottom plate are a rectangular shape.

Hydraulic support rods are arranged between the movable door and the side plates, one end of one hydraulic support rod is fixed on one side of the movable door and the other end is fixed on one side of one side plate away from the bottom plate; when the movable door is opened, the hydraulic support rod is configured to support the movable door so that the movable door is in an open state, which is convenient for an user to interact with or feed a pet; and when the movable door is closed, the hydraulic support rod is configured to slow down a closing speed of the movable door.

Middle portions of each of the movable door, the side plates and the first panel are provided with an observation window made of a transparent material.

A limit ring assembled on a location where the bottom plate, the top plate, the side plates, the first panel and the second panel are riveted.

A plurality of ventilation holes are formed in the top plate.

After adopting the above technical solution, the beneficial effects of the present disclosure are as follows. By arranging the box body as a structure formed by means of riveting several flat plates, the box body can be assembled more easily in use, while ensuring the stability of the box body; in addition, the box can be disassembled into several flat plates when not in use, so that several flat plates can be stacked and placed, thereby saving placement space.

### BRIEF DESCRIPTION OF THE DRAWINGS

In order to explain the embodiments of the present disclosure or the technical solutions in the prior art more clearly, the following will briefly introduce the drawings that need to be used in the description of the embodiments or the prior art. Obviously, the drawings in the following description are only some embodiments of the present disclosure. For those of ordinary skill in the art, other drawings can be obtained based on these drawings without creative labor.

FIG. 1 is a schematic diagram of the structure of Embodiment 1.

FIG. 2 is a schematic diagram of the exploded structure of Embodiment 1

FIG. 3 is a schematic diagram of the exploded structure of the first panel of Embodiment 1.

FIG. 4 is a schematic diagram of the exploded structure of Embodiment 1.

FIG. 5 is a schematic diagram of the exploded structure of the side plate of Embodiment 1

FIG. 6 is a use state diagram of Embodiment 1.

FIG. 7 is a use state diagram of Embodiment 2.

FIG. 8 s a schematic diagram of the structure of the movable door of Embodiment 2.

FIG. 9 is a schematic diagram of the structure of the side plate of Embodiment 2.

Reference numeral: 10. box body; 11. bottom plate; 12. side plate; 13. first panel; 14. second panel; 17. top plate; 21. hydraulic support rod; 15. movable door; 18. transparent observation window; 19. limit block; a. active cavity; f. ventilation hole; 16. support plate; 20. limit ring; d. gripping opening; e. passage opening.

### DETAILED DESCRIPTION OF THE EXEMPLARY EMBODIMENTS

The present disclosure will be further described in detail below in conjunction with the drawings.

In order to explain the embodiments of the present disclosure or the technical solutions in the prior art more clearly, the following will briefly introduce the drawings that need to be used in the description of the embodiments or the prior art. Obviously, the drawings in the following description are only some embodiments of the present disclosure. For those of ordinary skill in the art, other drawings can be obtained based on these drawings without creative labor.

### Embodiment 1

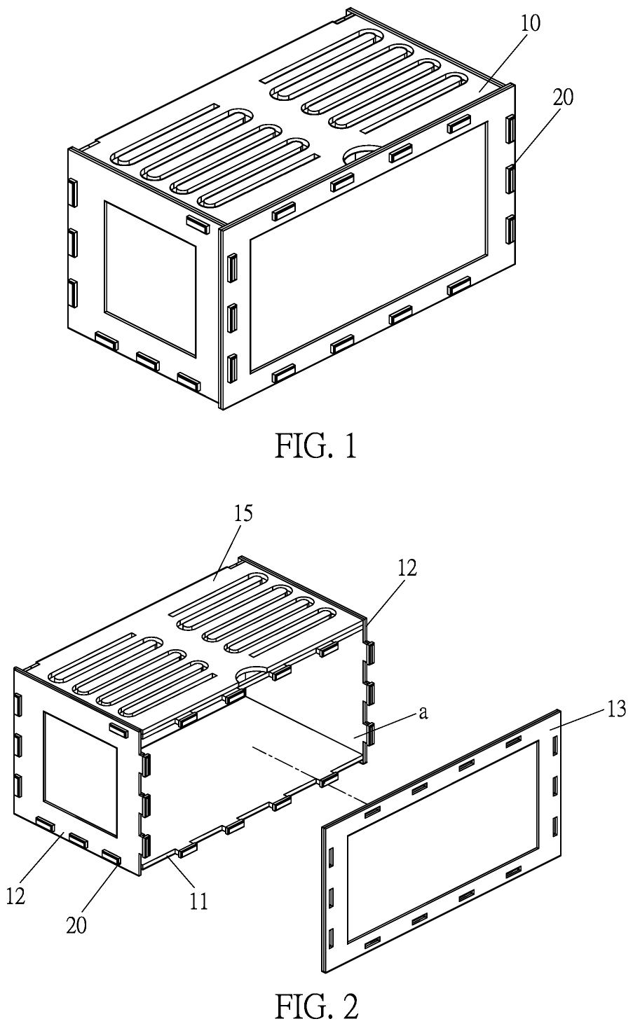

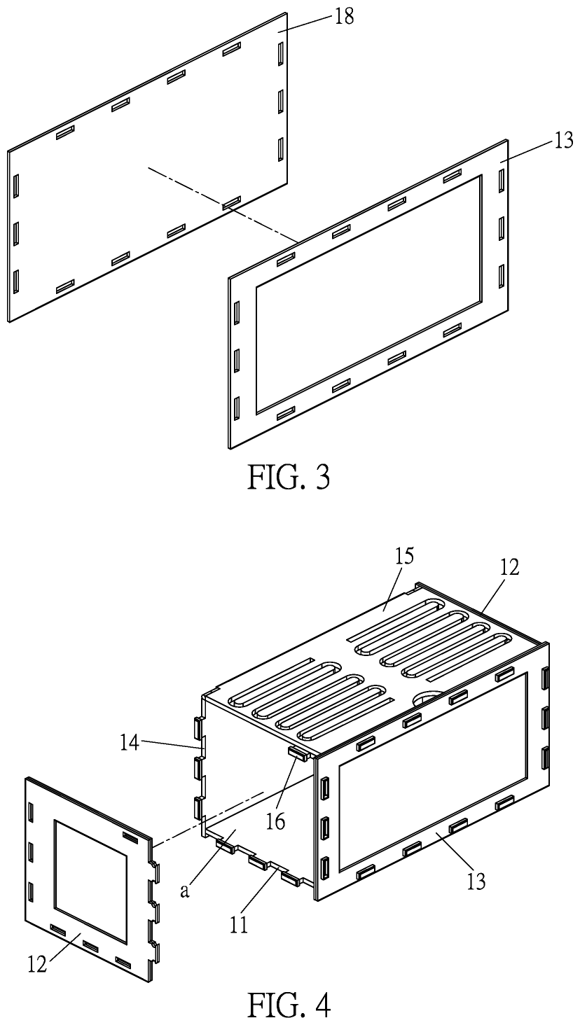

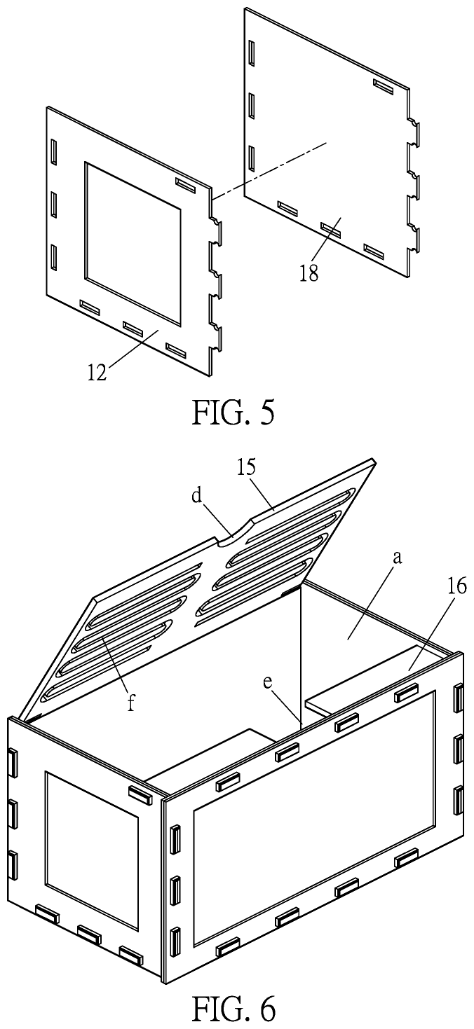

This embodiment relates to a hamster house, as shown in FIGS. 1-6, including a box body 10 and a movable door 15.

An active cavity a is provided inside the box body 10, an opening communicating with the active cavity a is provided on the box body 10, and the box body 10 is composed of riveting several flat plates, wherein the movable door 15 is hinged to the box body 10 and configured to cover the opening. Based on the above structure, by arranging the box body 10 as a structure formed by riveting several flat plates, the box body 10 can be easily assembled during use, and the stability of the box body 10 is ensured. In addition, when not in use, the box body 10 can be disassembled into several flat plates, so that several flat plates can be stacked and placed, thereby saving placement space.

Preferably, the box body 10 comprises: a bottom plate 11, side plates 12, a first panel 13 and a second panel 14.

Two side plates 12 are provided and riveted with two ends of the bottom plate 11, and the two side plates 12 are oriented to the same direction. The first panel 13 is arranged between the two side plates 12, the first panel 13 is oriented to the same direction as the side plates 12, two ends of the first panel 13 is riveted with one of the side plates 12 respectively, and the first panel 13 is arranged on one side of the bottom plate 11 and one side of the first panel 13 adjacent to the bottom plate 11 is riveted with the bottom plate 11. The second panel 14 is arranged between the two side plates 12, the second panel 14 is oriented to the same direction as the side plates 12, two ends of the second panel 14 are riveted with one of the side plates 12 respectively, and the second panel 14 is arranged on the other side of the bottom plate 11 corresponding to the first panel 13 and one side of the second panel 14 adjacent to the bottom plate 11 is riveted with the bottom plate 11. The movable door 15 is arranged on sides of the side plates 12 away from ground, and two ends of the movable door 15 adjacent to one side of the second panel 14 are respectively hinged to one of the side plates 12. The disclosure structure is convenient to install and disassemble the hamster house. Based on the above structure, by setting the box body 10 as a structure composed of the first panel 13, the side plates 12, the bottom plate 11 and the second panel 14, the size of the first panel 13, the side plates 12, the bottom plate 11 and the second panel 14 can be replaced and adjusted as needed, so as to obtain hamster house structures of different sizes according to customer requirements. In addition, since the first panel 13, the side plates 12, the bottom plate 11, and the second panel 14 are directly connected to each other through a riveting manner, no tools are needed in the process of disassembling the box body 10, which simplifies the installation and disassembly process of the hamster house. The box body 10 is set as a detachable structure, and after the box body 10 is disassembled, each part of the structure can be cleaned separately, so that when cleaning the entire box body 10, the range of accessibility is wider, and the box body 10 can be more conveniently cleaned.

Preferably, middle portions of each of the first panel 13 and side plates 12 are provided with a visible window made of a transparent material. The first panel 13 and the side plates 12 can be made of wood or rigid plastic panels. The visible window is made of acrylic sheet or glass, which is convenient to observe a pet's activities in the activity cavity a.

Preferably, the box body 10 further includes a support plate 16, both ends of the support plate 16 are riveted with one of the side plates 12 respectively, and one side of the support plate 16 adjacent to the first panel 13 is riveted with the first panel 13 to prevent the movable plate from sinking.

Preferably, a gripping opening d is provided on the movable door 15 and a passage opening e corresponding to the gripping opening d is provided on the support plate 16. Based on the above structure, when the movable door 15 needs to be opened, the hand is inserted into the grasping opening d, which can facilitate the grasping of the movable door 15. In addition, after the movable door 15 is covered, the movable door 15 is erected on the support plate 16, so even if the gripping opening d is opened, it is still difficult to grasp the movable door 15. The passage opening e is arranged on the support plate 16, and the hand is inserted into the passage opening e (to the side adjacent to the ground corresponding to the movable door 15), so that the movable door 15 can be grasped more easily and the movable door 15 can be opened easily.

Preferably, a limit ring 20 is removably assembled on a location where the bottom plate 11, the first panel 13, the second panel 14, the side plates 12, the movable door 15 and the support plate 16 are riveted. In order to facilitate the installation of the limit ring 20, the limit ring 20 can be set as an elastic limit ring 20 to ensure the further stability of the hamster house.

A plurality of ventilation holes f are formed in the movable door 15 to prevent the hamster from suffocating in the activity cavity a. In this embodiment, the ventilation holes f are set in an S-shaped structure.

### Embodiment 2

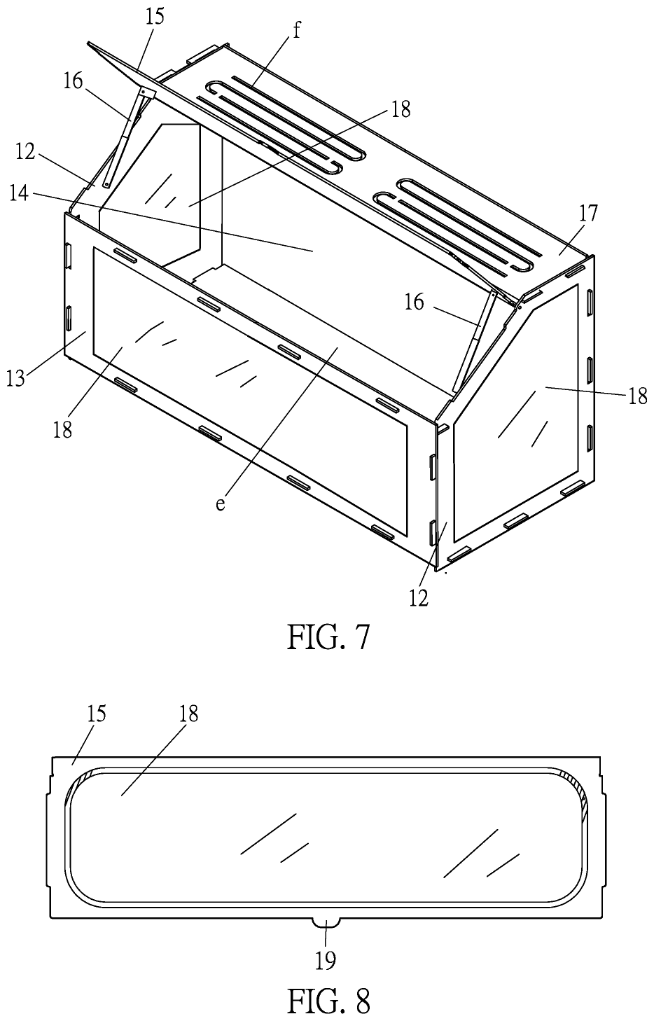

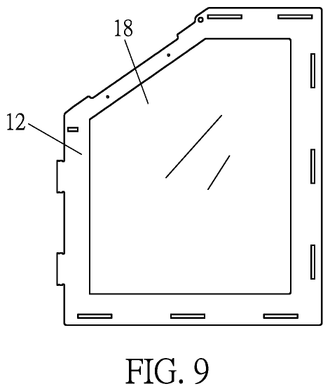

The main difference between this embodiment and the first embodiment is that, as shown in FIGS. 7-9, the box body 10 includes a bottom plate 11, side plates 12, a top plate 17, a first panel 13, a second panel 14 and a movable door 15.

Specifically, two side plates 12 are provided and fixed oppositely on two ends of the bottom plate 11. The first panel 13 is arranged between the two side plates 12, two ends of the first panel 13 are riveted with the two side plates 12 respectively, and the first panel 13 is arranged on one side of the bottom plate 11 and one side of the first panel 13 adjacent to the bottom plate 11 is riveted with the bottom plate 11. The second panel 14 is arranged between the two side plates 12, two ends of the second panel 14 are riveted with the two side plates 12 respectively, the second panel 14 is arranged opposite to the first panel 13, one side of the second panel 14 adjacent to the bottom plate 11 is riveted with one side of the bottom plate 11 away from the first panel 13, and a height of the first panel 13 is lower than a height of the second panel 14. The top plate 17 is arranged between the two side plates 12 and located on sides of the two side plates away from ground, two ends of the top plate 17 are riveted with the two side plates 12 respectively, and one side of the top plate 17 is riveted with the second panel 14. Two ends of one side of the movable door 15 are respectively hinged to sides of the two side plates 12 away from ground, one side of the movable door 15 is located on one side of the top plate 17 away from the second panel 14, and the other side is located on one side of the first panel 13 away from ground; or the movable door 15 is located between the two side plates 12, and one side of the movable door 15 is hinged to one side of the top plate 17 away from the second panel 14. In this embodiment, two ends of one side of the movable door 15 are respectively hinged to sides of the two side plates 12 away from ground, one side of the movable door 15 is on one side of the top plate 17 away from the second panel 14, and the other side is on one side of the first panel 13 away from ground. By arranging the box body 10 as a structure formed by several flat plates fixedly assembled with each other, the box body 10 can be assembled more easily during use, and the stability of the box body 10 is ensured. In some embodiments, the side plate 12 is rectangular, and a height of the first panel 13 is lower than a height of the second panel 14. The bottom plate 11, the side plates 12, the top plate 17, the first panel 13 and the second panel 14 are detachably assembled by screws.

Preferably, the two side plates 12 are both in a right-angled pentagonal shape, and parts of the side plates 12 adjacent to the top plate 17 are in a right-angle trapezoid shape and parts adjacent to the bottom plate 11 are a rectangular shape. By virtue of the above structure, the door can be opened with a bevel, which further facilitates an user to interact with or feed a pet.

Preferably, hydraulic support rods 21 are arranged between the movable door 15 and the side plates 12, one end of one hydraulic support rod 21 is fixed on one side of the movable door 15 and the other end is fixed on one side of one side plate 12 away from the bottom plate 11. When the movable door 15 is opened, the hydraulic support rod 21 is configured to support the movable door 15 so that the movable door 15 is in an open state, which is convenient for an user to interact with or feed a pet; and when the movable door 15 is closed, the hydraulic support rod 21 is configured to slow down a closing speed of the movable door 15. In this embodiment, the hydraulic support rod 21 is a gas spring hydraulic support rod 21 in the prior art. In this embodiment, two hydraulic support rods 21 are provided, which are respectively located between the two ends of the movable door 15 and the two side plates 12. In other embodiments, there is zero or one hydraulic support rod 21.

Preferably, middle portions of each of the movable door 15, the side plates 12 and the first panel 13 are provided with an observation window made of a transparent material. In this embodiment, the transparent observation window 18 is an acrylic plate, and the transparent observation window 18 is fixed on the movable door 15, the side plates 12 and the first panel 13 by screws. The movable door 15, the side plates 12, the first panel 13, the second panel 14, the bottom plate 11 and the top plate 17 are all made of wooden materials.

Preferably, a limit ring 20 is assembled on a location where the bottom plate 11, the top plate 17, the side plates 12, the first panel 13 and the second panel 14 are riveted.

Preferably, a plurality of ventilation holes f are formed in the top plate 17, which is convenient for a pet to breathe in the activity cavity a, and prevents a pet from suffocation and death. In this embodiment, the ventilation hole f is arranged in an S-shaped structure, which enlarges the area of the ventilation hole f, speeds up the frequency of air circulation, and increases the aesthetics of the box 10.

The above are only used to illustrate the technical solution of the present disclosure and not to limit it. Other modifications or equivalent substitutions made by those of ordinary skill in the art to the technical solution of the present disclosure shall be covered within the scope of the claims of the present invention as long as they do not depart from the spirit and scope of the technical solution of the present disclosure.

What is claimed is:

1. A hamster house, comprising: a box body (10) and a movable door (15), wherein an active cavity (a) is provided inside the box body (10), an opening communicating with the active cavity (a) is provided on the box body (10), and the box body (10) is detachably assembled by means of several flat plates, wherein the movable door (15) is hinged to the box body (10) and configured to cover the opening.

2. The hamster house according to claim 1, wherein the box body (10) comprises: a bottom plate (11), side plates (12), a first panel (13) and a second panel (14),
wherein two side plates (12) are provided and riveted with two ends of the bottom plate (11), and the two side plates (12) are oriented to the same direction,
wherein the first panel (13) is arranged between the two side plates (12), the first panel (13) is oriented to the same direction as the side plates (12), two ends of the first panel (13) is riveted with one of the side plates (12) respectively, and the first panel (13) is arranged on one side of the bottom plate (11) and one side of the first panel (13) adjacent to the bottom plate (11) is riveted with the bottom plate (11),
wherein the second panel (14) is arranged between the two side plates (12), the second panel (14) is oriented to the same direction as the side plates (12), two ends of the second panel (14) are riveted with one of the side plates (12) respectively, and the second panel (14) is arranged on the other side of the bottom plate (11) corresponding to the first panel (13) and one side of the second panel (14) adjacent to the bottom plate (11) is riveted with the bottom plate (11); and
wherein the movable door (15) is arranged on sides of the side plates (12) away from ground, and two ends of the movable door (15) adjacent to one side of the second panel (14) are respectively hinged to one of the side plates (12).

3. The hamster house according to claim 2, wherein middle portions of each of the first panel (13) and side plates (12) are provided with a visible window made of a transparent material.

4. The hamster house according to claim 2, wherein the box body (10) further comprises: a support plate (16), wherein two ends of the support plate (16) are riveted with one of the side plates (12), and one side of the support plate (16) adjacent to the first panel (13) is riveted with the first panel (13).

5. The hamster house according to claim 4, wherein a gripping opening (d) is provided on the movable door (15) and a passage opening (e) corresponding to the gripping opening (d) is provided on the support plate (16).

6. The hamster house according to claim 5, further comprising: a limit ring (20) removably assembled on a location where the bottom plate (11), the first panel (13), the second panel (14), the side plates (12), the movable door (15) and the support plate (16) are riveted.

7. The hamster house according to claim 2, wherein a plurality of ventilation holes (f) are formed in the movable door (15).

8. The hamster house according to claim 1, wherein the box body (10) comprises: a bottom plate (11), side plates (12), a top plate (17), a first panel (13), a second panel (14) and a movable door (15),
wherein two side plates (12) are provided and fixed oppositely on two ends of the bottom plate (11),
wherein the first panel (13) is arranged between the two side plates (12), two ends of the first panel (13) are riveted with the two side plates (12) respectively, and the first panel (13) is arranged on one side of the bottom plate (11) and one side of the first panel (13) adjacent to the bottom plate (11) is riveted with the bottom plate (11),
wherein the second panel (14) is arranged between the two side plates (12), two ends of the second panel (14) are riveted with the two side plates (12) respectively, the second panel (14) is arranged opposite to the first panel (13), one side of the second panel (14) adjacent to the bottom plate (11) is riveted with one side of the bottom plate (11) away from the first panel (13), and a height of the first panel (13) is lower than a height of the second panel (14),
wherein the top plate (17) is arranged between the two side plates (12) and located on sides of the two side plates away from ground, two ends of the top plate (17) are riveted with the two side plates (12) respectively, and one side of the top plate (17) is riveted with the second panel (14), and
wherein two ends of one side of the movable door (15) are respectively hinged to sides of the two side plates (12) away from ground, one side of the movable door (15) is located on one side of the top plate (17) away from the second panel (14), and the other side is located on one side of the first panel (13) away from ground; or the movable door (15) is located between the two side plates (12), and one side of the movable door (15) is hinged to one side of the top plate (17) away from the second panel (14).

9. The hamster house according to claim 8, wherein the two side plates (12) are both in a right-angled pentagonal shape, and parts of the side plates (12) adjacent to the top plate (17) are in right-angle trapezoid shape and parts adjacent to the bottom plate (11) are in a rectangular shape.

10. The hamster house according to claim 9, wherein hydraulic support rods (21) are arranged between the movable door (15) and the side plates (12), one end of one hydraulic support rod (21) is fixed on one side of the movable door (15) and the other end is fixed on one side of one side plate (12) away from the bottom plate (11); when the movable door (15) is opened, the hydraulic support rod (21) is configured to support the movable door (15) so that the movable door (15) is in an open state, which is convenient for an user to interact with or feed a pet; and when the movable door (15) is closed, the hydraulic support rod (21) is configured to slow down a closing speed of the movable door (15).

11. The hamster house according to claim 10, wherein middle portions of each of the movable door (15), the side plates (12) and the first panel (13) are provided with an observation window made of a transparent material.

12. The hamster house according to claim 11, wherein a limit ring (20) assembled on a location where the bottom plate (11), the top plate (17), the side plates (12), the first panel (13) and the second panel (14) are riveted.

13. The hamster house according to claim 12, wherein a plurality of ventilation holes (f) are formed in the top plate (17).
